(19) United States
(12) Patent Application Publication
(10) Pub. No.: US 2004/0111884 A1
(43) Pub. Date: Jun. 17, 2004

(54) Profiled contour of a screw pump

(76) Inventor: Ralf Steffens, Steinen (DE)

Correspondence Address: AKERMAN SENTERFITT, P.O. BOX 3188, WEST PALM BEACH, FL, 33402-3188, US

(21) Appl. No.: 10/466,643

(22) PCT Filed: Jan. 12, 2002
(86) PCT No.: PCT/EP02/00247

(30) Foreign Application Priority Data
Jan. 19, 2001 (DE) 101 02 341.3

(51) Int. Cl. B23P 15/00; B23C 1/00

(52) U.S. Cl. 29/888.023; 409/132

(57) ABSTRACT

The invention relates to the production of screw pump rotors comprising a pitch and/or depth of teeth which can be modified along the axis of the rotor. By means of a simple profiled machine tool (7), a first part of the profiled flank contour is clearly defined along the rotor axis (8) by means of its specific tool guide mechanism, and is then produced in a definitive manner. The remaining second part of the profiled flank contour is then determined according to the rolling movement of the pair of rotors according to the first part of the profiled flank contour carried out by the tool, by means of an approximation which is as precise as possible. It is thus possible to obtain transversally different profiled contours according to the pitch and/or depth of teeth which can be modified along the axis of the rotor. A disk milling cutter is selected to be used as a profiled machine tool.

The invention is concerned with the production of the profile of the pair of screw pump rotors, also called spindle rotors of a screw pump with internal compression by changing the pitch of the profile and/or the height of the teeth along the rotor axis of each of the screw pump rotors.

The invention further relates to a pair of screw spindles provided with the profile produced.

Such type screw pumps are known for example from DE 29 34 065 A1, 195 30 662 A1 or from WO 01/57401 A1 and gain importance in the vacuum technique in particular where they are employed as suction pumps since the known vacuum systems, which operate in a “wet” environment, such as liquid ring pumps and rotary vane pumps, are replaced with increasing frequency by dry pumps because of the ever growing requirements of the environmental regulations and increasing operating and disposal costs and because of the more stringent requirements for the purity of the medium to be pumped. These dry machines include screw pumps, diaphragm pumps, piston pumps, scroll machines and roots pumps.

All of these machines however fail to satisfactorily meet at low cost the demands often placed on reliability and robustness as well as on size and weight.

The dry screw pumps are increasingly utilized in the vacuum technique because, being typical twin shaft displacement machines, they simply realize the high compression capacity required in the vacuum technique by achieving the required multiple stages in a very uncomplicated manner by connecting in series a plurality of closed work chambers through the number of windings for each spindle rotor. Further, the non contact advance of the spindle rotors permits to achieve higher rotor speeds so that both nominal suction capacity and volumetric efficiency advantageously increase relative to the absolute size of the machine. Gas delivering screw pumps, as contrasted with fluid delivering screw pumps, rely on internal compression for reduced power consumption. According to the operating principle of a displacement machine, the gas volume trapped on the suction side is reduced by a selected factor while it is being delivered to the outlet, more specifically by reducing the pitch and/or the height of the teeth of the meshing screw spindles.

Concurrently, the non-contact rotation of the two displacement rotors implemented as screw spindles with as small a gap as possible between the spindle profile flanks requires the profile to have an outline capable of rotating in accordance with the known law of gearing in the x-y transverse plane, meaning normal to the longitudinal axis z of the rotor.

For producing helical rotors with a longitudinally variable pitch in accordance with the known prior art, a profile is selected in the x-y transverse plane which is capable of advancing in accordance with the known law of gearing, said profile being built up in the direction of the longitudinal axis of the rotor along a helical line extending in the direction of the z axis and having variably spaced apart windings by “building” the profile “up” in the sense of a “continuous stacking” operation, thus creating the desired helical rotor with a longitudinally variable pitch.

This can be readily designed or produced using a CAD system. Considerable difficulties arise however during manufacturing as it is mathematically obvious and compelling for manufacturing that the profile of the spindle varies along the rotor axis as a function of the pitch. For, with the buildup in the direction of the longitudinal axis of the rotor along the selected spiral or helical line as described, it is mathematically obvious and compelling that the outline of the tooth flank, which is clearly defined in the x-y transverse plane in accordance with the law of gearing, necessarily vary, both in the plane of the axial section and in the plane of the normal section as a function of the respective pitch which follows a desired function curve in the direction of the longitudinal axis of the rotor for realizing internal compression. This is where the technical difficulties arise in manufacturing as the rigid tools used for producing the helical groove only follow the profile of the flank in the axial or the normal section depending on the machining process chosen. With the profile of the flanks varying in these planes as described herein above along the rotor axis as a function of the respective value of the pitch, this manufacturing process, which makes use of the known tools, is complicated.

This problem is exacerbated by what is termed the “thread forming” at the end of the rotor located on the outlet side thereof: for achieving internal compression, the pitch decreases from the gas inlet side to the outlet side by the value of the desired internal compression so that the pitch is lowest at the outlet side. As a result, one faces the difficulty that, for manufacturing the spindle rotor, the selected tool must plunge quite deep into the spindle rotor to be machined to shape the flank as desired with the space between the teeth of the profile decreasing, which is only possible to a limited extent because of the stiffness of the tool chosen.

These difficulties related with the varying profile of the flanks in the plane of the axial or normal section in the longitudinal axis of the rotor are not encountered if the pitch is constant and the teeth of the profile have a constant height as this has long been known with fluid delivering screw pumps due to the near incompressibility of a fluid. It was the wish for providing a pitch that varies in the longitudinal direction for achieving power saving compression of a compressible medium to be pumped that gave rise to the difficulties outlined during manufacturing. Similar problems arise if the height of the profile teeth is additionally or alternatively varied in the longitudinal axis of the rotor in order to accomplish or increase internal compression.

The objective therefore is to allow low cost, easy manufacturing of helical rotors that implement internal compression by providing them with a pitch and/or a tooth height that varies along the rotor axis and to provide the suitable helical rotors.

In accordance with the invention, the solution to this object is achieved in that a simple profile machining tool clearly defines and finish machines, along the rotor axis, a first portion of the profile flank outline using its own characteristic manufacturing process with its specific tool guidance and that the remaining second portion of the profile flank outline is defined according to the advance movement of the pair of rotors and to said first portion of the profile flank outline defined by the tool through maximum approximation so that different profiles are obtained in the transverse section depending on the varying pitch and/or height of the teeth along the rotor axis. Accordingly, to form the profile, the first portion of the profile is directly defined and finish machined using a simple machining tool as said tool moves along the longitudinal axis of the rotor to produce the internal compression by varying the profile pitch and/or the height of the teeth and the other portion of the profile is defined according to the flank profile formed by the machining tool.

The term “simple tool” is to be construed herein as any workpiece independent tool. Accordingly, for manufacturing a spindle rotor as desired, it is not absolutely necessary to use a special, specific or particular tool.

The term simple tool is to be construed as any tool that produces various transverse sections along the longitudinal axis of the rotor, said “simple tool” defining the profile.

As this “simple”, that is workpiece independent tool, is guided through the workpiece, it machines a certain flank profile at the desired height or depth of the profile teeth, the shape of the flank profile being defined not only by the geometry of the tool but also, primarily, by the movement of the tool relative to the workpiece. Whereas the tool geometry, which is the initial value, does not change but is rather merely chosen at the start to serve as the initial value with regard to the smallest tooth space and to a good mean approximation of the profile as well as to low cost, the controlled movement of the tool relative to the workpiece is determining for influencing the profile geometry. There are various possibilities for controlling the movement of the tool, said possibilities depending on the machining machine chosen and having to be adjusted to the possibilities provided by said machine. A multiple axis machining center offers more possibilities but the invention can also be implemented using a simple cutting machine, the milling cutter of which, being used as a simple tool, may be inclined.

The possibilities for controlling and moving the simple tool are dictated by the machining machine and accordingly define the shape of the profile flank of the spindle rotor. The movement of the tool has to be controlled so as to form a suitable profile flank on the spindle rotor: for this purpose, a certain portion of the thus produced profile flank, preferably the dedendum, meaning the profile flank located below the pitch circle, is theoretically duplicated, consistent with the known law of gearing, on the other portion, preferably the addendum, meaning the profile flank located above the pitch circle, thus producing the corresponding theoretical second portion, meaning the addendum, according to the first portion, meaning the dedendum. This theoretical action, which is consistent with the known law of gearing, is performed either through an envelope or analytically through duplication by means of profile pitch functions. The peculiarity of the two identical spindle rotors displaying mirror-image symmetry is made use of so that the dedendum and addendum flanks always matingly mesh together.

Now, the two second profile sections, that is the shape actually produced by the simple tool, is directly compared with this theoretical shape: as a matter of fact, material of the actual profile is by all means to be prevented from projecting beyond the theoretical profile in the sense of a penetration into the advancing flanks, whereas, if the material of the actual profile does not reach the theoretical profile in the sense that there is a flank space, this lack of material generally needs only be minimized in the first place. This procedure is repeated at each transverse section that has a new pitch value. Individual/specific profiles are thus obtained with the various sections being adapted to be optimized differently. Accordingly, in the region of large pitch, the meshing line (as the stationary site of all points of meshing) is drawn as close as possible to the point of intersection of the two outside diameters (“minimum blowhole”), the material of the actual profile concurrently being minimally lacking as compared to the theoretical profile in the sense that a flank space is formed, whereas, with a small pitch, the meshing line is kept shorter with the lack of material being concurrently allowed to be greater.

The only input quantity is the desired shape of the pitch along the spindle rotor axis.

A distinctly different approach is used than is found in prior art in which a reference profile is given, said reference profile being kept constant for each transverse section and being approximated in the best possible way.

The invention described herein above can be implemented using known methods of manufacturing spindle rotors either by spinning, meaning by a motion of the tool about an inner axis, this motion requiring a kind of internal geared wheel with inward oriented turning chisels or by cutting.

It is thereby advisable to have the first portion of the profile, which is produced using the simple machining tool, forming the entire dedendum below the pitch circle.

The simple machining tool used for the first portion of the profile may be a face milling cutter. For the first portion of the profile, the simple machining tool can define and machine the two profile flank faces simultaneously in the zone of the smallest pitch.

Through selective control of the motion of rotation of the spindle rotor relative to the movement of the machining tool along the spindle rotor axis, the simple machining tool is capable of producing the desired variation in pitch.

More specifically, machining will proceed as follows: with a prior art simple face milling cutter being used as a first profile machining tool, which tool could also be a spinning material cutting tool, the rotor blank is initially machined in such a manner that the entire dedendum is completely finish machined. The dedendum is defined thereby as being the flank profile zone located below the pitch circle, meaning located deeper inside the workpiece than the pitch circle, with the pitch circle for the two spindle rotors, which preferably rotate at the same speed but in an opposite direction, corresponding to the spacing between the axes of the two spindle rotors.

The face milling cutter—or possibly the spinning tool—is preferably designed to have a geometry such that it is capable of completely machining the smallest pitch on the dedenda on the right and left face of the tooth space simultaneously. With the advancing motion of the face milling cutter in the direction of the longitudinal axis of the rotor—either with the tool or the workpiece being moved or with the two being moved relative to each other —the tooth space widens with increasing pitch so that the face milling cutter machines the one tooth space face (for example the commonly called “left” side) first and finishes the remaining dedendum face (the “right” one) in a subsequent machining step by modifying its inclination angle relative to the rotor axis.

To implement the desired internal compression, the pitch angle of the flank is modified relative to the longitudinal axis of the rotor consistent with the desired shape of the pitch. The machining angle of the face milling cutter—or an equivalent simple tool—is thereby inclined relative to the longitudinal axis of the rotor according to the desired function curve of the pitch angle of the flank or its inclination angle is adjusted or modified, also in space or in several planes. It is generally known that this change in the inclination angle of the axis of rotation of the face milling cutter is reliably achieved and ensured with the desired accuracy using modern manufacturing machines for manufacturing the flank profile as the tool is being moved along the rotor axis and this change can be controlled in space with precision.

Instead of longitudinally moving the face milling cutter several times relative to the workpiece, as this is required for machining the right and left dedendum flanks when the pitch is larger and the tooth space accordingly wider, it could alternatively be possible to machine the two tooth space faces simultaneously by accordingly inclining the face milling cutter at an excessive angle, which may lead to a somewhat less favorable profile, though.

For a particularly simple configuration of the profile flank roots it is also possible to maintain the machining angle of a face milling cutter unchanged relative to the longitudinal axis of the rotor and to achieve the desired variable pitch on the helical rotor by selectively controlling the motion of rotation of the workpiece relative to the movement of the face milling cutter along the rotor axis.

All of these possibilities are based on the inventive idea consisting in finishing the first portion of the profile flank outline to be formed, preferably the entire dedendum, using a simple machining tool, preferably a face milling cutter.

The face milling cutter used may advantageously be a prior art standard face milling cutter with standard cutter disks. After this machining step, the profile flanks of the spindle rotor located below the pitch circle are completed. With this provision, various profile outlines are now obtained in the transverse section (meaning normal to the longitudinal axis of the rotor).

Next, the respective one of the dedendum profiles, which has been clearly defined by the machining tool, for example the face milling cutter, is duplicated in each transverse section to the addendum profile consistent with the known law of gearing. Said dedendum profile may thereby possibly not be consistent with the known law of gearing but it is largely sufficient to produce the resulting addendum profile for example using an “envelope” or through simulation of the advance movement. A certain gap between the flanks of the cooperating rotors is needed anyway because of the non contact advance movement.

Moreover, the screw pumps having the known profiles (for example cycloidal profiles) between the two rotors in the addendum portion of the profile also have the known so-called “blowhole” which is also termed the “aperture of the rounded addendum”. Accordingly, the gap between the profile flanks, which, with this invention, is formed by the profile produced in relation with manufacturing, is always to be seen relative to the anyway existing gap widths, said gap widths determining to a much higher extent the internal leakage. As a matter of course, this additional gap, which is due to manufacturing, can for example be iteratively minimized by simply varying the geometry of the machining tool, a certain leakage between the flank faces being even favorable to an improved power distribution.

With this invention, it is particularly advantageous if the flank outlines of the dedendum and addendum profiles of the rotor and counter rotor are mating. As already mentioned herein above, the helical rotors are preferably caused to rotate at the same speed but in an opposite direction, the one spindle rotor being termed the “rotor” and the other one the “counter rotor”. For manufacturing reasons and in order to achieve uniform power conversion, it is advisable to have the profile flanks of the two rotors formed to have an identical configuration, with merely the orientation of the pitch direction being reversed. One rotor has a left-hand pitch and the other one a right-hand pitch, this being very easy to achieve by simply reversing the inclination of the machining tool, with all the other manufacturing parameters remaining unchanged. In each transverse section through the two rotors the profiles of the rotor and of the counter rotor are to be of an identical configuration, the transverse section varying as a function of the pitch, as already explained.

Advantageously, with the machining tool dictating the dedendum outline, the entire flank outline is clearly defined under the condition of identical outline, for the dedendum of the rotor always mates with the addendum of the counter rotor only and the addendum of the rotor with the dedendum of the counter rotor only so that, once a dedendum profile of the rotor has been determined, said outline is identically duplicated on the counter rotor and so that the resulting addendum profiles are also identical.

The production process described provides an elegant solution to basically mitigate the problem related with the forming of the thread as mentioned herein above which consists in finish machining the entire flank region located below the pitch circle, meaning the dedendum, by means of a face milling cutter or any other simple tool. The stiffness of the tool is thus considerably enhanced and, accordingly, the design limitations in determining the smallest pitch are more favorable.

The internal compression in a pair of helical rotors obtained by varying the profile pitch along the rotor axis has been described above in detail by way of example for this described implementation is the most commonly used as the suction chamber of the pump, which surrounds the two rotors, can thus be configured to be simply cylindrical at this level. As already mentioned, the tooth height can be modified either as an additional provision or as the only one in order to achieve the desired internal compression. For the volume of a respective work chamber is also modified in this way, which exactly corresponds to an internal compression. The procedure of the invention can also be used directly or indirectly with this approach which consists in the variation of the tooth height along the axis of the rotor. For this purpose, the tool or the face milling cutter is merely caused to execute one additional movement by modifying the distance between the rotor axis and the tool axis along the rotor axis during the machining process in order to produce a tooth height that varies along the longitudinal axis of the rotor. The method of producing a profile flank described above is kept identical and can be carried out together with the variation in pitch or separately. This selective change of the pitch angle of the flank and/or of the spacing between the two axes during the machining process in the longitudinal axis of the rotor can be performed without any problem using modern machining machines.

An exemplary embodiment of the invention is further described with reference to the drawing which shows in schematic form in

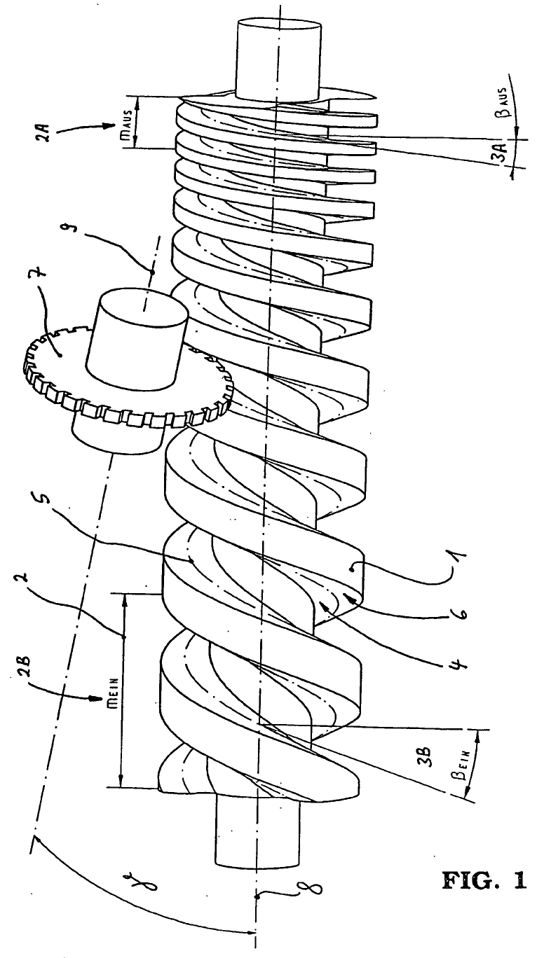

FIG. 1 a top or side view of a helical rotor with varying pitch along the rotor axis, with a milling cutter serving as a simple machining tool for machining the profile flank being illustrated at the same time and in

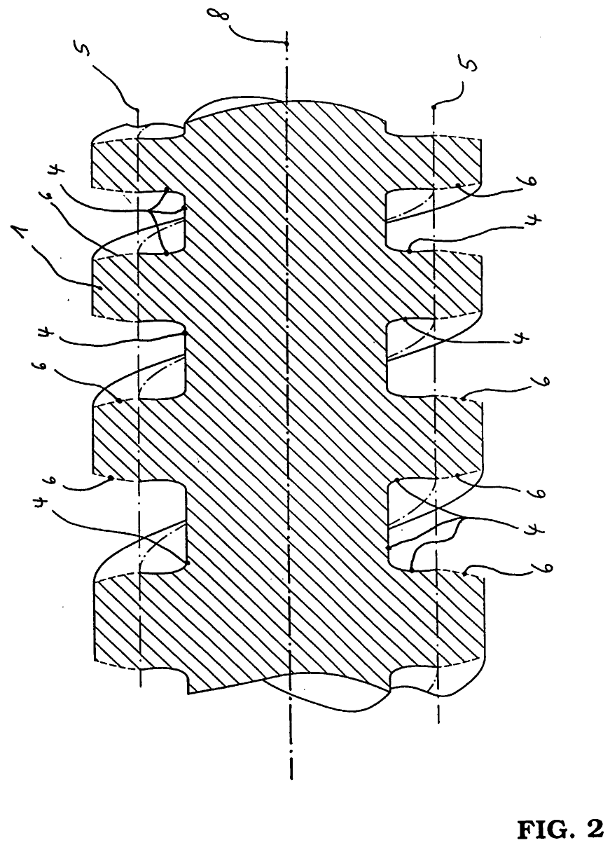

FIG. 2 a partial longitudinal section of the rotor on an enlarged scale.

In the illustrated exemplary embodiments, FIG. 1 is a top view of a helical rotor 1 with internal compression being achieved by varying the pitch 2 along the rotor axis, with the smaller pitch m_{Aus} 2A on the one rotor side and the larger pitch m_{Ein} 2B on the other side thereof and with the accordingly differing pitch angles β 3A and 3B of the flanks along the rotor axis. According to the invention, manufacturing with definition of the respective profile flank outline, which consists of the dedendum 4 below the pitch circle 5 and of the addendum 6 above the pitch circle, is carried out using a simple machining tool such as a face milling cutter 7 which, engaging into the spindle rotor 1, produces the profile flanks along the rotor axis 8 through selective movement. During the movement executed for machining the rotor profile, the axis 9 of the face milling cutter is inclined in the longitudinal direction of the rotor at the constant or varying angle γ relative to the rotor axis in order to produce the various pitch angles β of the flanks as described above according to the desired internal compression.

FIG. 2 is an enlarged axial section intended to illustrate the various profile flanks and showing the pitch circle (in the form of cylinder line 5), the dedendum (4—shown in thick full line and including the cylindrical diameter of the dedendum which the face milling cutter finish machines of course simultaneously) and the resulting outline of the addendum (6—shown in dashed line without cylindrical outside diameter).

1. A method of producing the profile of the pair of spindle rotors of a screw pump with internal compression by changing the pitch of the profile and/or the height of the teeth along the rotor axis, characterized in that the first portion of the profile is directly defined and finish machined using a simple machining tool during the movement thereof in the longitudinal axis of the rotor for generating the internal compression by changing the profile pitch and/or the height of the teeth and that the other portion of the profile is determined according to the flank outline produced by said machining tool.

2. The method according to claim 1, characterized in that the profile of a screw pump is obtained in that the first portion of the profile produced by the simple machining tool yields the profile of the entire dedendum below the pitch circle.

3. The method according to claim 1 or 2, characterized in that the machining tool for the first portion of the profile is a face milling cutter.

4. The method according to one of the claims 1 through 3, characterized in that the machining tool for the first portion of the profile defines and machines simultaneously the two faces of the profile flanks in the zone of the smallest pitch.

5. The method according to one of the claims 1 through 4, characterized in that the simple machining tool produces the desired change in pitch by selectively controlling the motion of rotation of the spindle rotor relative to the movement of the machining tool along the axis of the spindle rotor.
